(19) United States
(12) Patent Application Publication
(10) Pub. No.: US 2022/0367077 A1
(43) Pub. Date: Nov. 17, 2022

(54) Space-Based Radioisotope Production and Methods of Use

(71) Applicant: Atomos Nuclear and Space Corporation, Denver, CO (US)

(72) Inventor: Lucas Brady Beveridge, Denver, CO (US)

(73) Assignee: Atomos Nuclear and Space Corporation, Denver, CO (US)

(21) Appl. No.: 17/736,083

(22) Filed: May 3, 2022

Related U.S. Application Data
(60) Provisional application No. 63/184,138, filed on May 4, 2021.

(51) Int. Cl. G21D 5/02; B64G 1/40; G21C 3/42

(52) U.S. Cl. CPC G21D 5/02; B64G 1/408; G21C 3/42

(57) ABSTRACT

The disclosure describes various aspects of a space-based radioisotope production system and methods use. In one aspect, a propellant is accelerated by decay energy to yield thrust. The decay energy is provided by activating a target material. In one aspect, a radioisotope rocket thruster may be recharged or “reactivated” in a space-borne charging station. The activated isotopes may also be used generate electricity. The space-borne charging station may also be used for irradiating other items in space for any number of purposes.

### CROSS REFERENCE TO RELATED APPLICATIONS

This application is related to U.S. Provisional Patent Application Ser. No. 63/184,138, filed May 3, 2021, and U.S. Provisional Patent Application Ser. No. 63/246,712, filed Sep. 21, 2021, the content of which applications are incorporated herein by reference in its entirety.

### BACKGROUND OF THE DISCLOSURE

Aspects of the present disclosure generally relate to a rocket thruster system, and more specifically, to a space-based isotope production system and method of use.

Many nuclear propulsion concepts have been proposed over the decades, using the heat from a reactor or radioisotope to either generate electricity for an electric thruster, or directly heat a propellant. In the case of the latter, the specific impulse is severely limited by the temperature of the materials and lifetime is limited by the corrosive nature of the low molecular weight propellants (such as hydrogen). In the case of the former, the reactor requires a heavy power conversion system such as Brayton or Rankine conversion with complex and expensive components that are difficult to make reliable enough for a spacecraft. Additionally, the nuclear-electric system requires a massive heat rejection system to dump waste heat, and heavy shielding to protect the payload from gamma-rays and neutrons.

Radioisotope thrusters have also been proposed, but to date require isotopes produced on Earth and integrated with a thruster during manufacturing. This conventional approach restricts the options to isotopes that are longer lived that may be handled and launched before expiration (such as Pu-238, or Po-210). However, longer lived isotopes have very low activity (low power density), and due to practical and safety limitations, the thrusters are quite small and low thrust. Only one known thruster concept has a relatively high-power density due its use of a shorter-lived alpha emitter such as Po-210 to generate a high-voltage potential between electrodes in an electrostatic thruster (See U.S. Pat. No. 3,184,915 to Low et al, incorporated by reference in entirety for all purposes).

Further, various reactor configurations and isotope production systems are deployed for terrestrial applications. For example, the High Flux Isotope Reactor at Oak Ridge National Laboratory is described as being based on the flux trap principle, in which the reactor core consists of annular regions of fuel surrounding an unfueled moderating region. The fast neutrons leaking from the fuel are moderated in the moderating region, thus producing a region of very high thermal-neutron flux that is “trapped” within the reactor (See “High Flux Isotope Reactor Technical Parameters,” Oak Ridge National Laboratory, https://neutrons.ornl.gov/hfir/pararneters (accessed May 1, 2022). Again, such reactors for isotope production are currently limited to earth-bound constructions.

### SUMMARY OF THE DISCLOSURE

The following presents a simplified summary of one or more aspects to provide a basic understanding of such aspects. This summary is not an extensive overview of all contemplated aspects, and is intended to neither identify key or critical elements of all aspects nor delineate the scope of any or all aspects. Its purpose is to present some concepts of one or more aspects in a simplified form as a prelude to the more detailed description that is presented later.

The disclosure overcomes the significant limitations of conventional nuclear propulsion concepts to include conventional radioisotope thruster concepts operated in space.

The disclosure describes various aspects of space-based radioisotope production system for use in a variety of use scenarios, such as a radioisotope rocket thruster and in-space charging station.

In an aspect, a propellant is accelerated by decay energy to yield thrust. The decay energy is provided by activating a target material. In one aspect, the thruster may be recharged or “reactivated” in a space-borne charging station. The activated isotopes may also be used generate electricity. The space-borne charging station may also be used for irradiating other items in space for any number of purposes.

In one aspect of a thruster application, a propellant is injected into a stream of ionizing radiation to yield thrust. The stream of ionizing radiation is provided by activating a target material.

In one embodiment, the stream of particles is controlled by a magnetic field to travel in a circular route within a thrust chamber encapsulating the propellant.

In some embodiments, a radiation absorbing substance is added to the propellant to facilitate heating of the propellant.

In one aspect, the thruster may be recharged or “reactivated” in a space-borne charging station.

In some embodiments, a space-borne radioisotope power system includes a chamber containing a target material, a neutron source in space for producing neutrons. The neutrons are used for activating the target material to produce a radioisotope material. The radioisotope material produces decay energy, and a propellant receives the decay energy to produce at least one of heat and electricity.

In other embodiments, a method for operating a space-borne radioisotope power system includes providing a space-borne radioisotope power system. The space-borne radioisotope power system includes a neutron source and a chamber containing a target material. The method further includes interfacing the space-borne radioisotope power system with a client spacecraft in space. The method also includes producing neutrons using the neutron source, activating the target material using the neutrons to produce a radioisotope material, producing decay energy from the radioisotope material to produce at least one of heat and electricity, and using the at least one of heat and electricity to provide power to the client spacecraft interfaced with the space-borne neutron source.

In another aspect, the client spacecraft may have been launched without radioactive material, then interfaced in space with a space-borne charging station equipped with a reactor or neutron source to activate an inert material on the spacecraft to enable the use of radioactive decay on the spacecraft while in space.

In still another aspect, the method further includes providing an orbital transfer vehicle for navigating the client spacecraft to the space-borne radioisotope power system. In an embodiment, the orbital transfer vehicle may also be charged at the space-borne neutron source.

### BRIEF DESCRIPTION OF THE DRAWINGS

The appended drawings illustrate only some implementation and are therefore not to be considered limiting of scope.

FIG. 1 is a representation of one example of a space-borne radioisotope power system using space-based isotope production, in accordance with an embodiment.

FIG. 2 illustrates a sequence of some steps of a method of use of the space-borne radioisotope power system using space-based isotope production of FIG. 1, in accordance with an embodiment.

FIG. 3 is cut-away side perspective representation of one embodiment of a radioisotope rocket thruster engine taking advantage of a space-based isotope production system.

FIG. 4 is an example graph of Reactor Neutron Flux vs. Decay Specific Power for Phosphorus, in accordance with an embodiment.

FIG. 5 is a representation of a space-borne neutron source-based recharging station, in accordance with an embodiment.

FIG. 6 is a table of activation values for a 5 kg Phosphorous sample, in accordance with an embodiment.

FIG. 7 is a representation of one reactor geometry of a space-borne neutron source, in accordance with an embodiment.

FIG. 8 is a representation of another reactor geometry suitable for use with a space-borne radioisotope power system, in accordance with an embodiment.

FIG. 9 is a representation of a flux-trap reactor including a radiation shield suitable for use within a space-borne radioisotope power system, in accordance with an embodiment.

FIG. 10 is a representation a space-borne neutron source interfacing with a client spacecraft, in accordance with an embodiment.

FIG. 11 is a table of activation results of the reactor geometry of a space-borne radioisotope power system using 5 kg of phosphorus as target material, in accordance with an embodiment.

FIG. 12 is a graph of Total Neutron Cross Section for Phosphorous-31, in accordance with an embodiment.

FIGS. 13A-13C is a table of materials suitable for use as a target material in a space-borne radioisotope power system, in accordance with an embodiment.

FIGS. 14-16 illustrate exemplary concepts of operations of a space-borne radioisotope power system and neutron source, in accordance with some embodiments.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form to avoid obscuring such concepts.

The present disclosure describes various embodiments of a space-borne radioisotope power system for providing power, heat, electricity, and/or thrust for objects in space. For instance, a space-borne reactor or other neutron source (such as a fusion reactor or particle accelerator) may be used to make an inert material radioactive on a client spacecraft for the purpose of using the radioactive decay for some purpose on that client spacecraft (such as generating electric power or thrust). The neutron source may be connected to its own spacecraft (bus) for the purpose of operating it remotely in space, and remains separate from the client spacecraft. The neutron source and its bus may be referred to as a “charging station.” In an example, this station may nominally stay parked in an orbit (e.g., around earth or another object) for use as stationary infrastructure to service client spacecraft. This configuration allows client spacecraft to launch without radioactive material, alleviating launch safety issues and reducing costs.

In an embodiment, the radioisotope power system is used for producing thrust by directing a stream of ionizing radiation to heat and react a propellant, wherein the ionizing radiation is generated by activating a target material. For instance, while beta decay has been utilized in the past to directly produce electricity for terrestrial applications and beta batteries are even sold commercially, the limited supply of isotopes produced by conventional means and safety requirements limits the applications for this type of power source. Furthermore, no known thruster concept uses a flux trap-based reactor to generate a radioisotope in space.

As an example, a space-borne radioisotope power system may be used as a radioisotope rocket thruster system to produce thrust by directing a stream of beta particles to heat a propellant, the beta particles generated by decay of an activated target material. Stated another way, the rocket thruster system is a spaceborne radioisotope power system. Activation of the target material occurs in situ, in the space environment. In an embodiment, a propellant is injected into a beta particle stream to produce thrust. The thrust is directed through a nozzle. In one embodiment, the stream of beta particles is controlled by a magnetic field within a thrust chamber encapsulating the propellant.

As disclosed herein, the spaceborne reactor system for producing the radioisotope relies on relatively short-lived isotopes (with half-lives of hours to months or a few years) made by activating readily available stable elements (such as phosphorus or scandium) while in space. Such stable elements are referred to in the disclosure as “target material.” A beta emitter may be used partly because most naturally occurring elements activate into beta emitters, and the particles are easily deflected with magnetic fields and/or are easily absorbed to generate heat. The beta particles may be steered into long cyclic paths (i.e., longer than the mean free path of the beta particles in the gas) to allow the beta particles to collide with propellant or other thruster components to deposit electric charge or heat. Due to the short half-life and to alleviate launch safety issues, the system activation may occur in space.

Within the present disclosure, the term “isotope” means any of two or more forms of a chemical element having the same number of protons in the nucleus (i.e., the same atomic number) but having different numbers of neutrons in the nucleus, or different atomic weights. The phrase “beta particle” means a high-speed electron or positron emitted by radioactive decay or reaction of an atomic nucleus.

In one embodiment, a reactor with a neutron flux trap large enough to contain the thruster with target material(s) and an opening for a spacecraft to insert the thruster resides in orbit as a kind of “charging station” that may be used by multiple spacecraft. Such reactors may be placed at various orbits or destinations (such as Mars orbit, Lunar orbit, geo-stationary orbit, etc.) so that spacecraft may be re-activated for return trips or other maneuvers. Such an embodiment may be incorporated as part of a multi-orbital transfer vehicle constellation system, as described in U.S. patent application Ser. No. 16/986,517 to Clark, incorporated by reference in entirety for all purposes.

Preliminary analysis shows that, for example, with natural phosphorus as a target material with resulting phosphorus-32 (14-day half-life, 1.7 MeV beta), a power density of 1 kW per kg of phosphorus is feasible. If the propellant mass flow rate is adjusted such that the Isp is 2000 sec., then the resulting initial thrust is about 0.1 N per kg of phosphorus. The resulting thruster has similar specific power to electric thrusters, but without the need for a power-supply, power-conversion, radiation shielding, or power transmission, resulting in a spacecraft specific mass of at least an order of magnitude lower than conventional electric spacecraft. Other shorter lived activated target elements such as manganese may produce higher thrust and specific power, albeit for much shorter durations. It is noted that the term “Isp” or “Iₛₚ” refers to specific impulse, which is a measure of impulse delivered to a vehicle per unit of propellant consumed, and thus measured how efficiently propellant is consumed.

Although the disclosed devices, systems, and methods of use will be described relative to space-borne radioisotope rocket thruster, the devices, systems, and methods of use have other applications. For example, the method and/or devices disclosed herein may be used in terrestrial applications.

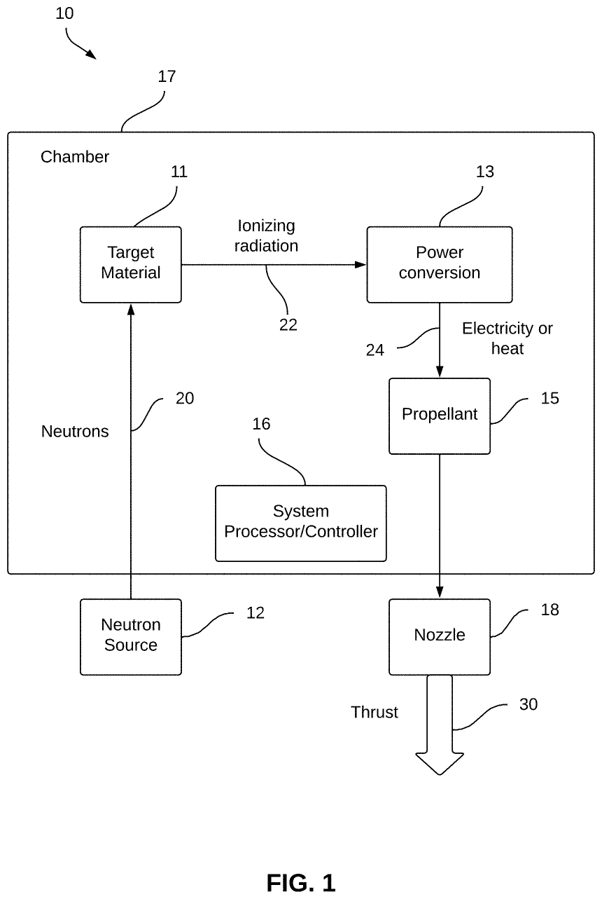

The disclosed devices, systems, and methods of use will be described with reference to FIGS. 1-16.

FIG. 1 describes one embodiment of a radioisotope power system 100, used as a rocket thruster system. Generally, radioisotope power system 10 includes a target material 11, a neutron source 12, a power conversion system 13, a propellant 15, a system processor/controller 16, a chamber 17, and a nozzle 18. The components shown enclosed within chamber 17 (seed/target material 11, power conversion system 13, propellant 15, and system processor/controller 16 in the example illustrated in FIG. 1) may collectively be referred to as a “radioisotope power system and neutron source” or simply “activation engine.”

Target material 11 is, for example, a stable element that forms a radioisotope material when impacted by a stream of neutrons. Once activated, target material 11 emits ionizing radiation, and radioactive decay is ongoing once activated. Candidate target materials may also include yttrium, which activates into Y-90, and other target materials known to those skilled in the art.

Neutron source 12 emits neutrons 20. Neutrons 20 are directed at target material 11 to activate target material 11 and produce or create radioisotope material and ionizing radiation 22.

Neutron source 12 may be a nuclear reactor with a neutron flux trap in one embodiment. Alternatively or additionally, neutron source 12 may be any type of fusion reactor, to include any device that produces or emits neutrons through a fusion reaction, such as for example solar-powered neutron generators. In one embodiment, neutron source 12 is a particle accelerator. Note that once target material 11 is activated, neutron source 12 may be removed from or distanced from the radioisotope engine for radioisotope engine operation.

Ionizing radiation 22 emitted from the radioisotope material formed by target material 11 is received by power conversion system 13, which controls the movement or kinematics of ionizing radiation 22. Power conversion system 13 receives ionizing radiation 22 and outputs or creates heat or electricity 24. A broad objective of power conversion system 13 as shown in FIG. 1 is to direct ionizing radiation 22 to interact with propellant 15 in a manner that creates power and/or thrust 30.

System processor/controller 16 may control one or more aspects or components of radioisotope rocket thruster system 10. For example, system processor/controller 16 may control the rate of emission of neutrons 20 from neutron source 12, and/or control or set parameters for power conversion system 13.

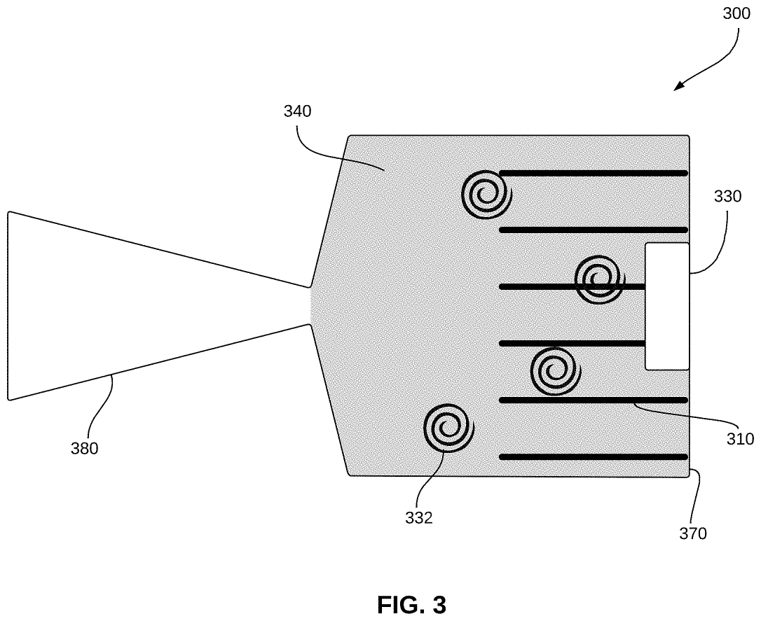

Power conversion system 13 may employ any one or more mechanisms to control ionizing radiation 22. In one embodiment, power conversion system 130 creates and employs a magnetic field to control or direct ionizing radiation 22 into a controlled beta particle stream forming a curvilinear route (see FIG. 3). In such a configuration, power conversion system 13 may employ a set of permanent magnets and/or electromagnets. Alternatively or additionally, power conversion system 13 may employ other mechanisms to direct or control ionizing radiation 22, such as electrostatic fields and other mechanisms known to those skilled in the art.

Electricity or heat 24 from power conversion system 13, is directed to propellant 15. In one embodiment, propellant 15 is contained within and occupies the entirety of chamber 17. In an example, electricity or heat 24 is provided as a beta particle stream moving in a spiraled pattern within chamber 17 so as to remain within chamber 17 (and thus also within propellant 15) until the beta particles are absorbed or stopped by the propellant (see FIG. 3). In an exemplary embodiment, propellant 15, upon receipt of electricity or heat 24, creates or produces thrust directed via nozzle 18. In some embodiments, a beta absorbing substance is added to propellant 15 to facilitate heating of the propellant.

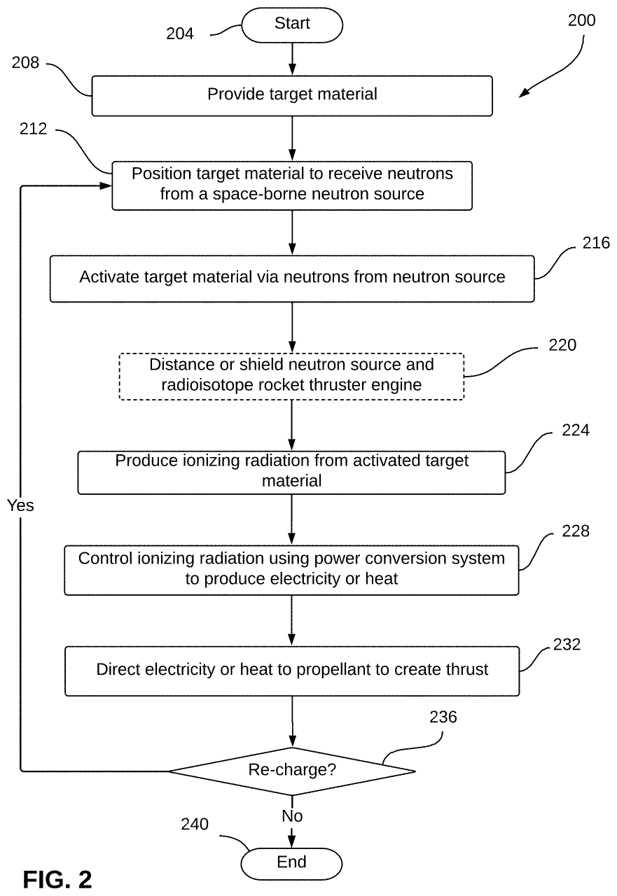

FIG. 2 presents one embodiment of a method 200 of use of radioisotope power system 100 of FIG. 1. Stated another way, FIG. 2 illustrates a sequence of some steps of a method of use of the radioisotope power system as exemplified in FIG. 1.

Any of the steps, functions, and operations discussed herein with respect to FIG. 2 may be performed continuously and automatically (such as, e.g., with aid or use of a processor/controller such as system processor/controller 16 of FIG. 1). In some embodiments, one or more of the steps of the method may be implemented by computer control, use of computer processors, and/or some level of automation. The steps are notionally followed in increasing numerical sequence, although, in some embodiments, some steps may be omitted, some steps added, and the steps may follow other than increasing numerical order.

As shown in FIG. 2, after starting at step 204, method 200 proceeds to a step 208 wherein a target material, is provided. The target material may be, for example, a part of a radioisotope power system 10 of FIG. 1.

Method 200 then proceeds to a step 212, at which the target material is positioned to receive neutrons from a neutron source, such as neutrons 20 from neutron source 12 of FIG. 1. As described above, neutron source 12 may be any of several types or configurations. In embodiments of step 212: 1) a radioisotope rocket thruster engine containing the target material engages with or docks with a neutron source; 2) the radioisotope rocket thruster engine is placed within a neutron source; 3) the radioisotope rocket thruster engine is carried by or detachably engaged with a spacecraft; and/or 4) the spacecraft is configured to place the radioisotope rocket thruster engine within or adjacent the neutron source and then maneuver itself away from the neutron source, or place itself behind a protective shield that absorbs harmful radiation.

Method 200 then proceeds to a step 216, at which the neutrons emitted or provided by the neutron source are directed to the target material, resulting in creation of an activated target material. As discussed above, once the target material is so activated, the target material produces ionizing radiation.

Continuing to refer to FIG. 2, at an optional step 220, the neutron source and the target material are separated or distanced. In embodiments of step 220: 1) the radioisotope rocket thruster engine containing the target material undocks from the neutron source; 2) the spacecraft of step 216 attaches with the radioisotope rocket thruster engine and removes or undocks the radioisotope rocket thruster engine from the neutron source; and/or 3) the radioisotope rocket thruster engine is shielded from the neutron source.

Then, at a step 224, ionizing radiation is produced as a result of the creation of activated target material from the previously inactive target material.

At a step 228, the radioactive emission is controlled by a power conversion system, such as power conversion system 13 of FIG. 1. In an embodiment, the power conversion system operates to direct or control the movement or kinematics of a beta particle stream to create a controlled beta particle stream, such as controlled beta particle stream. In other embodiments, power conversion system may convert the ionizing radiation received thereon into heat and/or electricity. As described above, the power conversion system may employ one or more methods or techniques to control the radioactive emission, such as electro or permanent magnets.

At a step 232, the heat or electricity is provided to a propellant (e.g., propellant 15 housed in chamber 17) thereby producing thrust. As described above, in one embodiment, the power conversion system directs or controls the radioactive emission so as for a circular or spiral route so as to remain within the enclosed chamber that encapsulates or contains the propellant. In one embodiment, the propellant flows through a radioisotope rocket thruster engine, the propellant heated by beta particles via collisions with gas molecules while in the chamber (e.g., chamber 17 of FIG. 1) and producing thrust. In an embodiment, the radioisotope rocket thruster engine will continue to produce thrust until the activated radioisotope is no longer radioactive (or propellant is exhausted). In one embodiment, thrust so produced is directed through a nozzle (e.g., nozzle 18 of FIG. 1). The nozzle may be a traditional bell-shaped diverging nozzle. Alternately or additionally, the nozzle may be a magnetic nozzle of any nozzle design known to those skilled in the art.

At a step 236, a query is made as to whether the target material should be re-charged (i.e., the target material is no longer radioactive and must again receive neutrons from a neutron source to be reactivated). If the reply is YES, method 200 returns to step 212. If the reply is NO, method 200 proceeds to step 240 and ends.

FIG. 3 is cut-away side view of one embodiment of a radioisotope rocket thruster engine 300. Radioisotope rocket thruster engine 300 includes internal structures 310 containing a target material. The structures may be positioned within a chamber 340, which contains, for example, propellant 140. Beta particles, which are emitted from internal structures 310 when activated by neutrons, are controlled by a radioactive emission control system (such as power conversion system 13 of FIG. 1 or configured as a magnet 330 in FIG. 3) to create a controlled radioactive emission 332. For example, controlled beta particle stream 332 forms spiral or circular tracks so as to remain within the chamber for a longer period than beta particles initially emitted by the activated target material without being controlled by a radioactive emission control system. Note that other configurations of internal structures 310 may be employed, e.g., a set of concentric rings of varied diameter, the rings symmetrical about a central axis of chamber 340.

The radioisotope power systems the present disclosure employ short-lived (and thus high-power density) isotopes to thermally heat a low-pressure gas (i.e., the temperature is high enough to ionize this gas, and is a plasma upon exit). The radioisotope is produced by capture of thermal neutrons in a target material resulting in activation. A low-pressure propellant reduces the heat flux to the walls and engine components. Therefore, unlike a nuclear thermal rocket, the melting point of the materials is not a limiting factor in the deployment of the radioisotope power systems described above. In some cases, a magnetic nozzle may still be required.

The power density and thrust duration of the disclosed radioisotope rocket thruster systems may be adjusted based on the application. For example, phosphorus or yttrium may be used for high thrust, shorter burn durations (14-30 days), and scandium may be used for longer duration, lower thrust applications. Furthermore, target materials may be mixed in one engine where high thrust is needed early, and low thrust later (for initially climbing out of a gravity well, and then slowly accelerating afterwards). The thrust and Isp may also be varied by using multi-mode injection schemes, or by using hypergolic propellants such as hydrazine or ASCENT (Advanced Spacecraft Energetic Non-Toxic) propellant in combination with a catalyst bed (Note: ASCENT, formerly known as AF-M315E, is an advanced monopropellant formulation developed by the Air Force Research Laboratory (AFRL) Rocket Propulsion Division (RQR)). For instance, an element like manganese may be advantageous for laboratory-based, proof of concept experiments. Further, manganese may also be used in very short high-thrust missions. As an example, ⁵⁵Mn activates into ⁵⁶Mn, which has a 2.57 hour half-life with a 2.8 MeV beta, which means a more modest neutron source (such as a particle accelerator at a university) may activate a small amount and produce a significant thrust. In this case, with 1 hour of irradiation of 10 g of Mn at 10¹⁵ n/cm²/s produces about 120 watts initially, equates to 12 mN of thrust (for Isp=2000 seconds). This short operating life is advantageous for, for example, laboratory settings because the radioisotope does not remain highly radioactive for very long, thus improving laboratory safety considerations.

A great deal of neutron activation is possible with a relatively simple reactor design based on the concepts described herein, and calculations show that achievable neutron fluxes (<10¹⁵ n/cm²/s) in existing reactors may produce an initial decay power in phosphorus greater than 1 kW/kg. However, even at lower neutron fluxes, good specific power may be achieved using the concepts described herein. The quantity of activated isotopes reaches an equilibrium after some length of time, which is a function of half-life and neutron flux. For phosphorus, the equilibrium is reached in about 60 days, and the asymptotic limit is higher with higher neutron fluxes. If a lower specific power is acceptable, then irradiation time may be reduced, and this helps to extend reactor life.

Shown below is a list of candidate propellants, such as propellant 140. Other propellants 140 are possible, as known to those skilled in the art.
Ammonia (NH₃)
Alcohol (Ethanol, Methanol, lsopropanol, etc.)
Noble gasses (Xenon, Argon, Helium, Neon, Krypton)
Water (H₂O)
Heavy water (D₂O)
Diatomic gasses (H₂, N₂, O₂, etc.)
Organic compounds (CO₂, CO, CₙH₂ₙ₊₂, CₙH₂ₙ₋₂, etc.)
Other compounds (SF₆ depleted UF₆)
Storable rocket propellants (peroxides, kerosine, hydrazine and its derivatives, ASCENT, etc.)

Shown below is a table of candidate target materials that may serve as radiation sources, such as target material 11 of FIG. 1 and target material within internal structures 310 of FIG. 3. Some other isotopes such as Co-60 produce high energy gamma rays as well that could be absorbed in a dense refractory metal to generate heat. Isotopes that decay into alpha emitters could be used in some thrusters as well (such as Bismuth, which decays into Po-210 after neutron activation).
Phosphorus
Scandium
Manganese
Sodium
Silicon-30, requires enrichment
Potassium-41, requires enrichment
Copper-63, requires enrichment
Zinc-68
Yttrium
Cobalt
Bismuth
Europium
Arsenic
Sulfur
Calcium-44, requires enrichment
Krypton
Rubidium
Strontium
Zirconium-94, requires enrichment

It is noted that the decay energy from the activated target material may be used to increase the enthalpy of a propellant to produce heat to be converted to thrust. Alternatively, the energy from the radioactive decay may also be used to accelerate propellant to a high exhaust velocity by some other means than heat. For instance, electricity matched to the requirements of the thruster (e.g., derived from the decay heat or directly from the radiation) may be used to power an electric thruster. This heat-to-electricity or radiation-to-electricity conversion may be performed by any system that produce voltage and current output that is matched to the desired electric thruster inputs. This conversion to electricity eliminates the need for power conditioning equipment to change or regulate the voltage and current, resulting in significant reduction in the overall system mass.

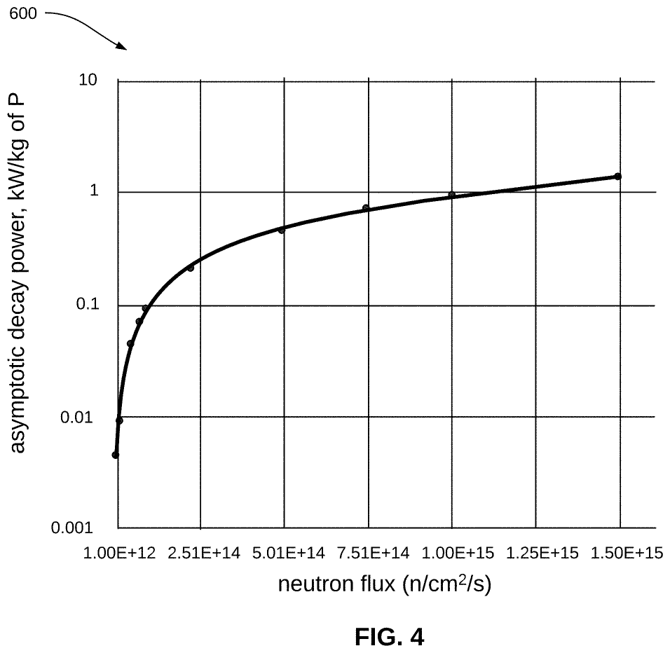

FIG. 4 shows peak specific power for phosphorus target material over a range of reactor neutron fluxes.

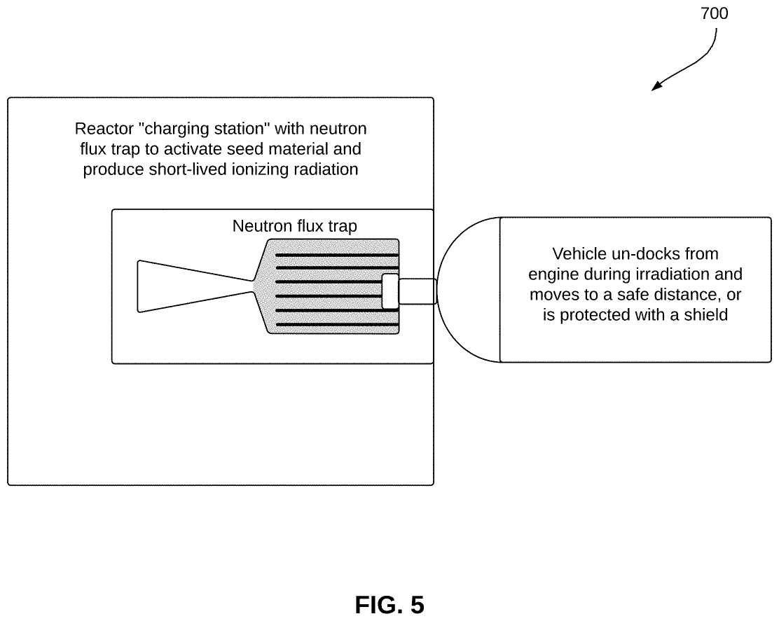

FIG. 5 is a representation of a radioisotope rocket thruster engine being activated in a flux trap. Such a neutron flux trap may be suitable to use as, for instance, neutron source 120 of FIG. 1. Since the radioisotope rocket thruster engine requires many thermal neutrons to produce enough radioisotope (activation product), a rather high-power reactor is needed. However, the reactor for the disclosed radioisotope rocket thruster system has far less restrictive requirements than conventional space-reactors for power and propulsion. Because the reactor is to be placed into a permanent orbit, the mass is only constrained by what may be launched. Furthermore, as the neutron flux trap is only used as a neutron source, there is no power conversion, and it can be made to run very hot to dissipate waste heat. A (satellite) bus would still be necessary for attitude control, communication, station-keeping, etc., thus likely necessitating a large shield and truss to prevent radiation damage. Some waste heat may be utilized to power conventional electric propulsion on the bus for maneuvering and station-keeping. The waste heat may be utilized for other industrial uses as well such as nuclear research, in addition to providing significant electrical power for other spacecraft, experiments, or manufacturing. The reactor may serve as a multi-purpose space station.

Some simplified reactor models have been evaluated using the OpenMC continuous-energy particle transport reactor physics code (although other neutron transport codes such as MCNP or Serpent could also be used). The reactor uses high-assay low-enriched (HALEU) fuel for lower cost and regulatory restrictions.

In particular, a simplified model engine was included in the OpenMC reactor model to determine the neutron capture rate with phosphorus-31 target material. This OpenMC model is simulating the fission in the reactor as well as neutron scattering and thermalization; thus, there are no assumptions about neutron energy or flux being made to estimate the activation. The target material included a reduced density to approximate a void in the engine. The volume-averaged neutron flux was also measured in the reactor fuel and in the engine. To determine the specific power of the engine, the number of transmuted target atoms must be determined. The average neutron flux may be used to independently verify the neutron capture rate in the target material by solving the system of ordinary differential equations for capture and decay:

$$\{ \begin{matrix}\frac{{dN}_{P 31}}{dt} = - {ϕσ}_{P 31} {N}_{P 31} ( t ) \\ \frac{{dN}_{P 32}}{dt} = {ϕσ}_{P 31} {N}_{P 31} ( t ) - {λ}_{P 32} {N}_{P 32} ( t )\end{matrix} \qquad [ Eq . 1 ]$$

N_{P31} and N_{P32} are the numbers of the respective phosphorus isotopes, φ is the neutron flux (n/cm²/s) (from OpenMC tally result), σ_{P31} is the thermal neutron capture cross section for ³¹P, and λ_{P32} is the decay constant of ³²P. Additionally, ³²P does not have an appreciable capture cross section even at thermal energies, so only ³¹P and ³²P are considered in this simple calculation.

After solving for N_{P31} and N_{P32}, the decay power may be calculated as p=Ap₃₂ N₃₂ Ep, where E is the energy of the emitted beta particle (1.7 MeV for ³²P). For a neutron flux of 10¹⁵ n/cm²/s, and an irradiation time of 60 days (when the ³²P population reaches equilibrium) and 5 kg of ³¹P the population of ³²P atoms is 2*10²², which is an initial decay power of 4.3 kW, and a specific power of 0.863 kW/kg. This same calculation may be done using the NIST Activation Calculator (https://www.ncnr.nist.gov/resources/activation/.)

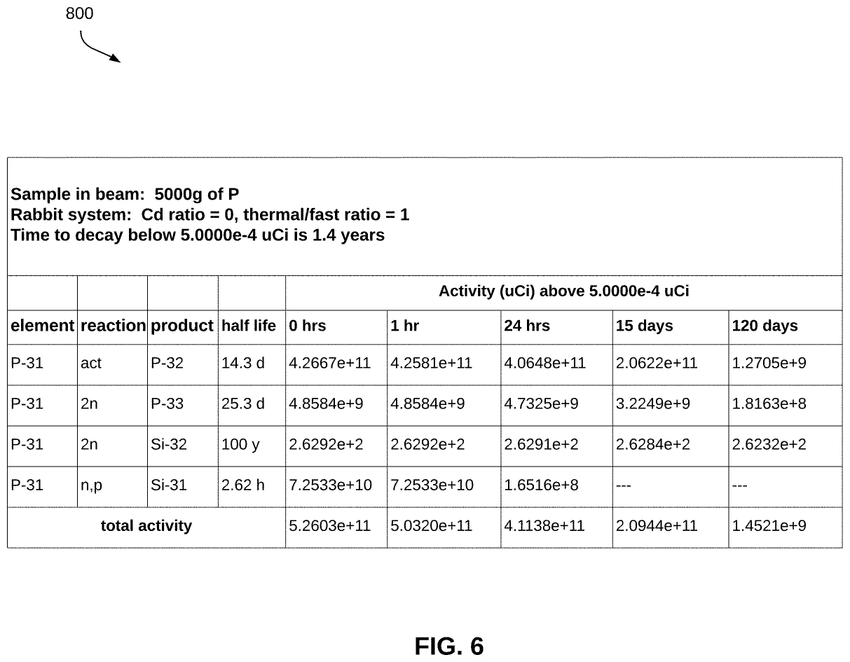

FIG. 6 shows a table of calculation results representing the activity of ³²P. The initial decay rate 4.26*10¹¹ μCi the ³²P is equivalent to 4.28 kW, which is nearly identical to the previous calculation. The capture rate in ³¹P was also tallied in OpenMC along with the neutron flux coupled with reactor neutronics and criticality calculations, and the reactor power was adjusted until a comparable engine decay power was reached.

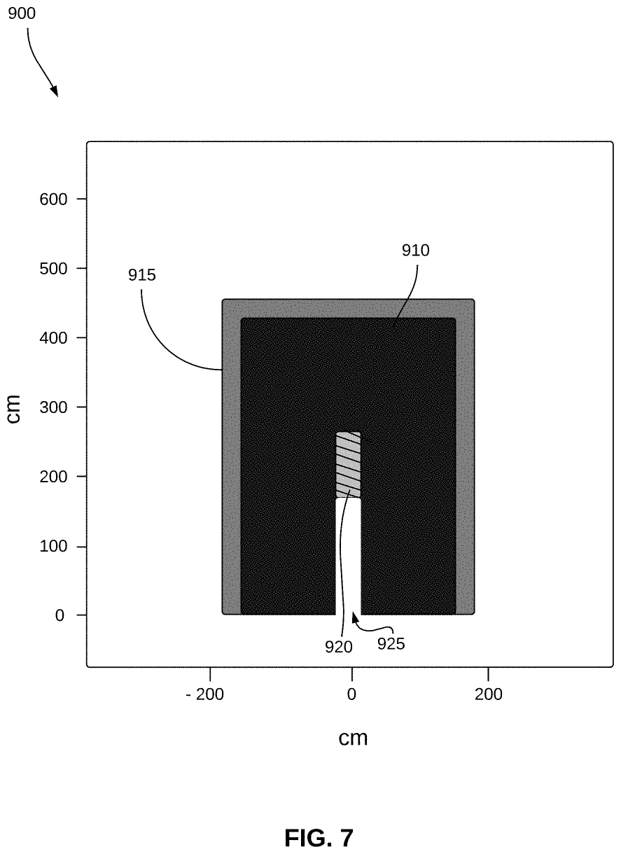

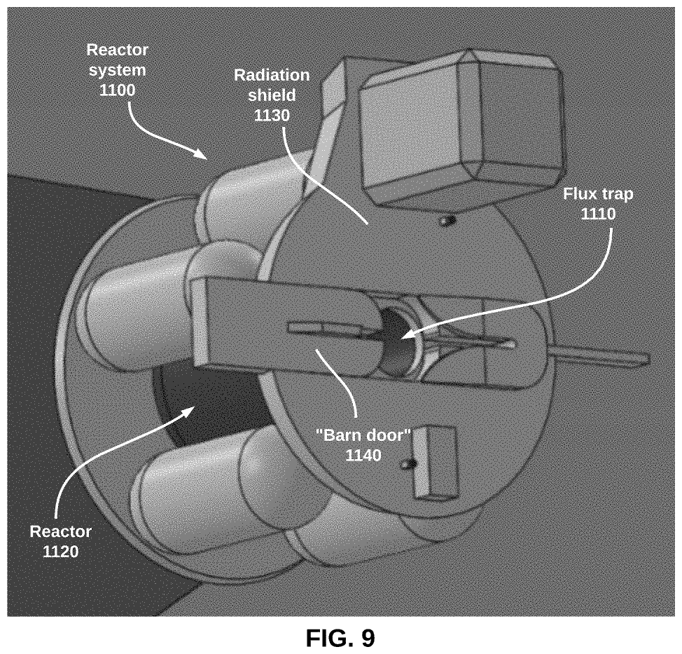

FIG. 7 is a representation of one reactor geometry 900 of a charging station reactor. As shown in FIG. 7, reactor geometry 900 includes a black portion 910 representing fuel and graphite, a gray portion 915 representing a BeO moderator, and a hatched portion 920 representing phosphorus seed and void contained within an open end 925 of a flux trap. Reactor geometry 900 was developed using the OpenMC continuous-energy particle transport reactor physics code (other evaluation codes may also be used). A TRISO (TRi-structural ISOtropic) fuel surrounds a heavy-water (deuterium-oxide) moderator. Within the moderator is the cavity where the thruster/target isotope is placed. The cavity acts to concentrate neutrons from the reactor. The graphite and uranium oxide in the TRISO fuel both may tolerate extremely high temperatures (>3000K), and the graphite serves as a moderator. However, this is not an optimal reactor design, and the moderator needs to be kept as cool as possible to slow down the neutrons as much as possible. Lower temperature moderators and fuels may also save mass. Additional flux traps could also be implemented in a single reactor to service multiple spacecraft simultaneously (similar to the many flux traps in the Advanced Test Reactor at Idaho National Laboratory), thus increasing the capacity of the “charging station”. Additionally, one spacecraft may have multiple thrusters/batteries that are charged/activated simultaneously. It is noted that the example reactor geometry illustrated in FIG. 9 is only shown as an example of the magnitude of performance possible, and is not to be considered a limiting example.

Other reactor geometries, such as containing 500 kg or more or phosphorus as target material, are contemplated. In such larger reactor configurations, the solid fuel may not be easily replaced after being consumed. Therefore, in some embodiments, a molten fuel may be used in a manner similar to a terrestrial molten salt reactor. This configuration allows for a larger fuel load that may be stored outside the reactor and circulates through the core, thus extending the life of the reactor and makes it easier to potentially replace the fuel. Such a configuration would also allow many more engines to be charged during the life of the reactor, making it more economical to implement. As a variation, a pebble-bed core would also allow potential online refueling as well as better heat transfer. The flux trap may be further improved using an ultra-cold moderator surrounding the cavity, such as frozen deuterium (at just a few kelvin). This will greatly increase the neutron capture in the engine target by lowering the neutron thermal energy.

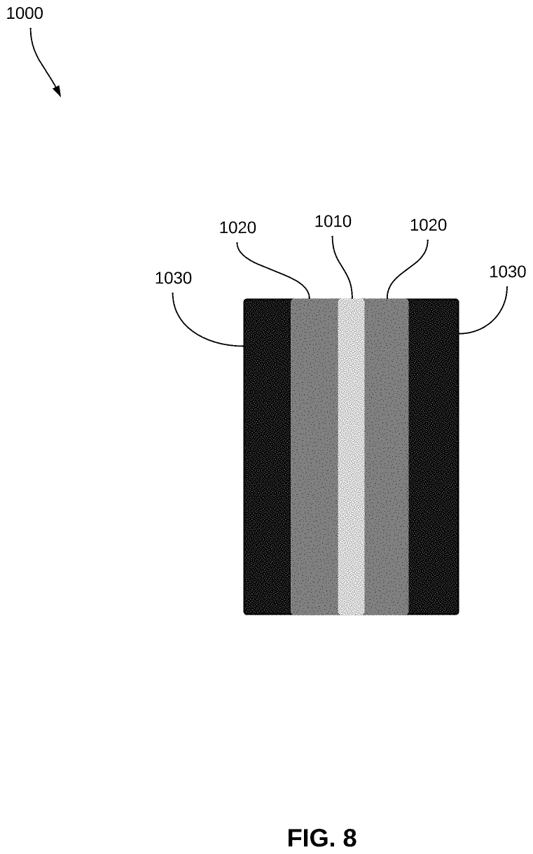

An alternative configuration of a reactor geometry is shown in FIG. 8. A flux-trap reactor 1000 includes target material 1010 surrounded by a neutron moderator 1020 and a reactor fuel region 1030. Target material 1010 may be replaced by or include, for instance, batteries and/or thrusters. Filling the full length of the flux-trap cavity with target isotope in this way is the most efficient configuration, capturing the maximum neutron flux.

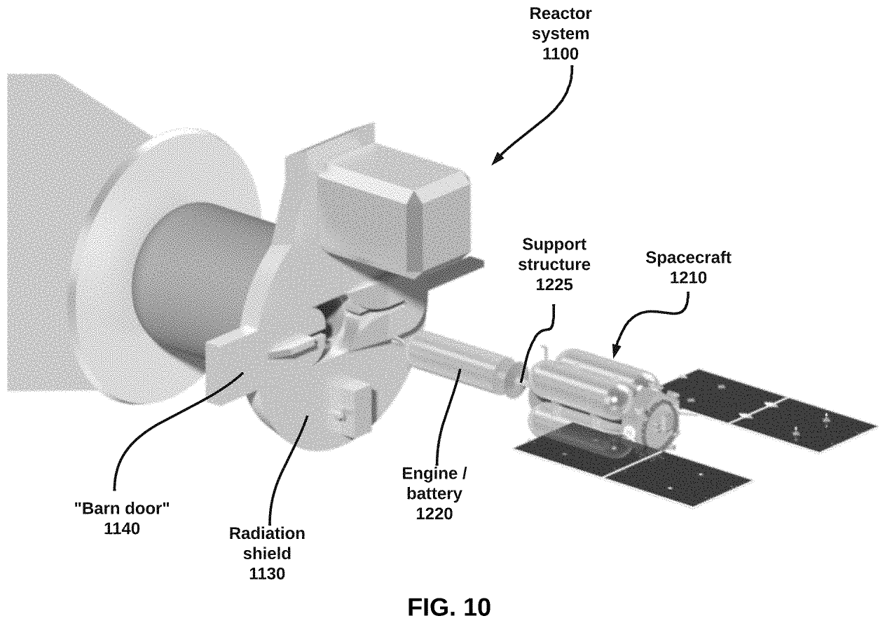

FIG. 9 illustrates a reactor system 1100 including a reactor shield, in accordance with an embodiment. As shown in FIG. 9, reactor system 1100 includes flux trap 1110 with a reactor 1120. A radiation shield 1130 protects any object near an opening of flux trap 1110 from radiation from reactor 1120. Radiation shield 1130 includes a sliding “barn door” mechanism 1140 for enabling access to flux trap 1110, as more clearly seen in FIG. 10.

As shown in FIG. 10, an external spacecraft 1210 by access flux trap 1110 by inserting an engine/battery 1220 into the opening accessible when barn door mechanism 1140 is open. In the example of FIG. 10, engine/battery 1220 from spacecraft 1210 is supported on a support structure 1225 The barn doors in radiation shield 1130 can close around engine/battery 1220 while only leaving thin support structure 1225 exposed, thus protecting spacecraft 1210 from radiation produced by reactor system 1100 during irradiation. Support structure 1225 may also contain shield material to fill any gap in the barn door, thus providing further protection for spacecraft 1210.

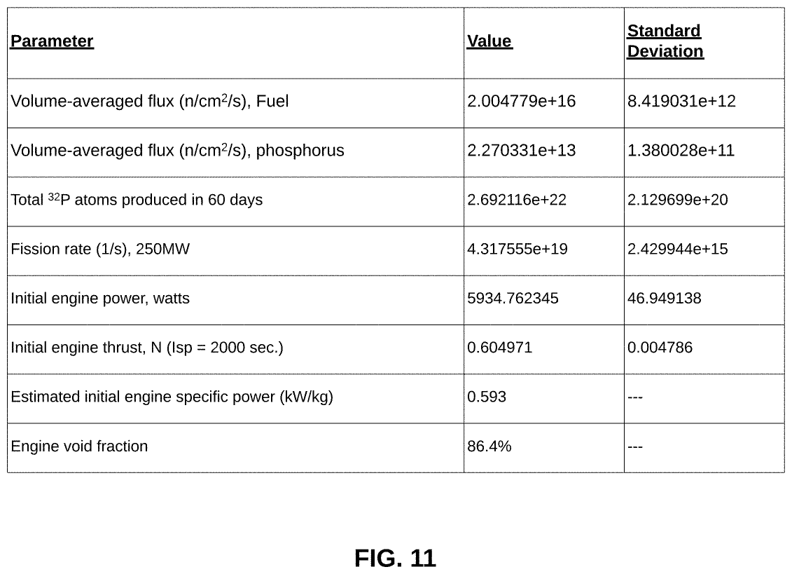

FIG. 11 is a table of activation results of the reactor geometry of a radioisotope power system using 5 kg of phosphorus as target material. More specifically, the table of FIG. 11 shows the flux and activation results for 5 kg of ³¹P and reactor model, including initial engine power and thrust. Specific power is estimated by assuming the engine inert mass is equal to the phosphorus mass.

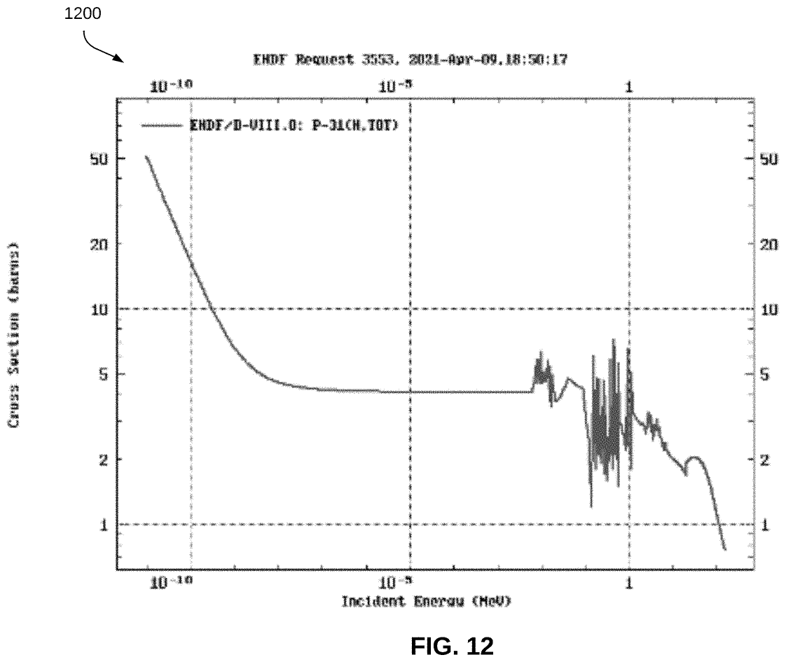

FIG. 12 shows the total neutron cross section (proportional to reaction rate) for phosphorus-31, for illustrating the increase in the neutron capture at low energy (temperature). The horizontal axis of FIG. 12 is incident neutron energy in units of MeV, where 0.0253 eV is equivalent to room temperature. At cryogenic temperatures, the cross section may be more than 10× larger than at room temperature. Therefore, for the same reactor power and neutron flux, the activation and thus engine specific power may increase by at least 10×. While keeping a moderator at cryogenic temperatures while a reactor is running at full power may be challenging, such efforts may increase engine specific power to greater than 10×.

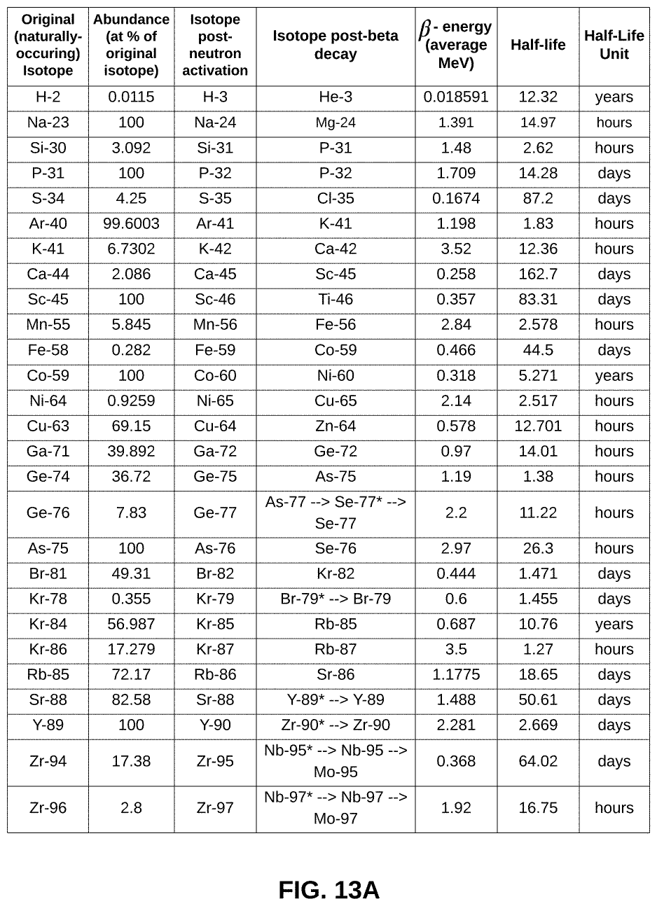

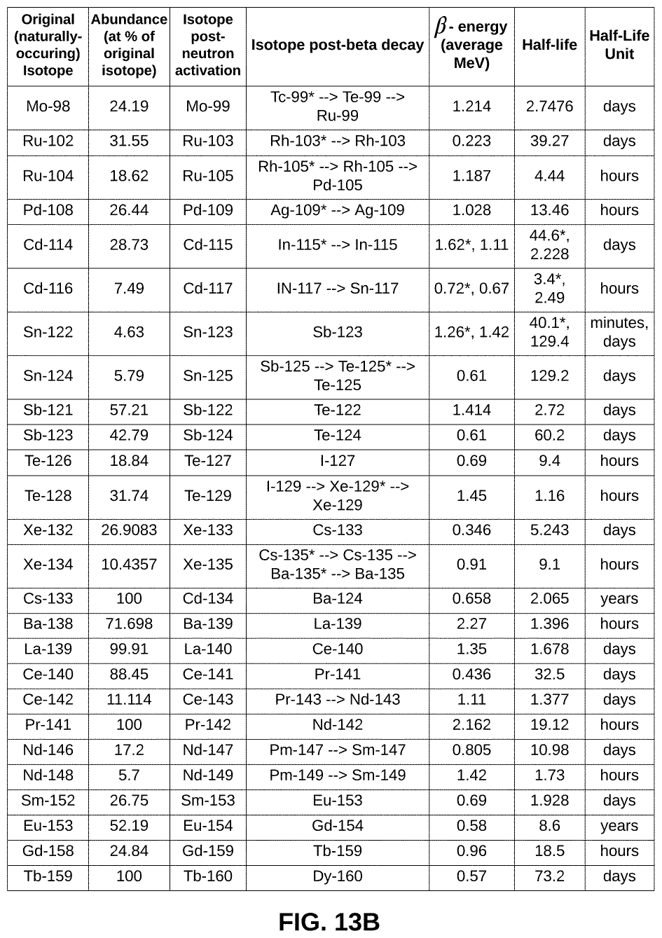

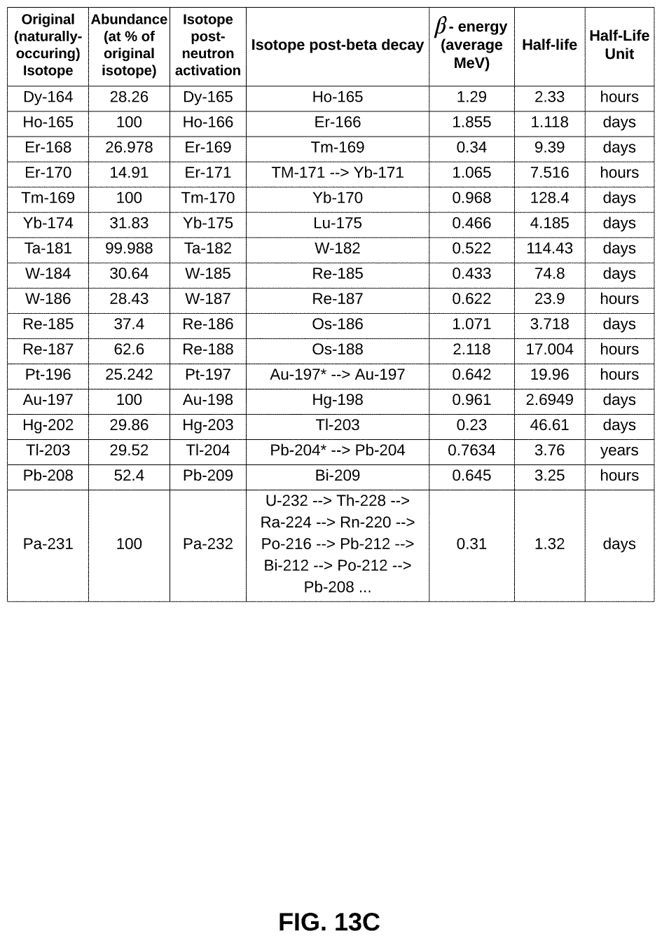

Further possibilities for materials suitable for use as a target material in the aforedescribed space-borne radioisotope power system are listed in the table shown in FIGS. 13A-13C. It is noted that this list is not intended to be comprehensive. In particular, the table shown in FIGS. 13A-13C mainly lists beta emitters, although isotopes that are primarily alpha and gamma emitters may also be used.

The disclosed radioisotope power system may serve a whole class of thrusters and power sources because there are so many possible engine configurations that benefit from space-based in-situ isotope production. For instance, space-based in-situ isotope production could activate a thin bismuth coating on a collapsed isotope sail to produce Po-210, which emits alpha particles from a thin plastic sheet to produce thrust with extremely high Isp. See, for example, R. L. Forward, “Radioisotope sails for deep space propulsion and electrical power,” 31st Joint Propulsion Conference and Exhibit, San Diego, Calif., 1995, which publication is incorporated by reference in entirety for all purposes.

An activation rocket may have a mix of target material that activates into both short and long-lived isotopes to have high initial thrust and then lower, longer lived thrust. In addition to being ideal for orbital transfer vehicles, the disclosed radioisotope power system may be ideal for interplanetary probes because, in addition to activating thrusters, radioisotope batteries may also be charged in the same reactor. The charging station reactor (such as shown in FIG. 5) may serve as permanent infrastructure for supporting many different spacecraft. As such, the owners of the reactors may charge spacecraft operators for their use, similar to buying gasoline for a car.

There are myriad different propulsion and power systems that could benefit from charging in space. Such an arrangement could eliminate many of the logistical and safety issues involved with launching radioisotope systems from the ground, while also dramatically increasing performance of those systems due to the use of shorter-lived isotopes. Having the orbital infrastructure for servicing spacecraft with these high-performance thrusters and power systems enables new capabilities heretofore uncontemplated.

Furthermore, the disclosed radioisotope power system may be placed in multiple orbits for orbital transfer vehicles to make round trips between high and low orbits. For example, the reactors/charging stations may be placed in multiple orbits to service orbital transfer vehicles (OTVs) that contain the thrusters. There would also need to be reactors (or other neutrons sources) placed to re-charge the thrusters in those various orbits (See, e.g., U.S. patent application Ser. No. 16/986,517 to Clark, as cited above). They could also be placed at more distant destinations such as Mars or the asteroid belt, where they could be used for charging engines for return trips to Earth, or trips further out in the solar system. This system allows large and small spacecraft to move nearly anywhere in the solar system. It is conceivable to have large thrusters that produce hundreds of newtons of thrust and are capable of moving bulk cargo and people.

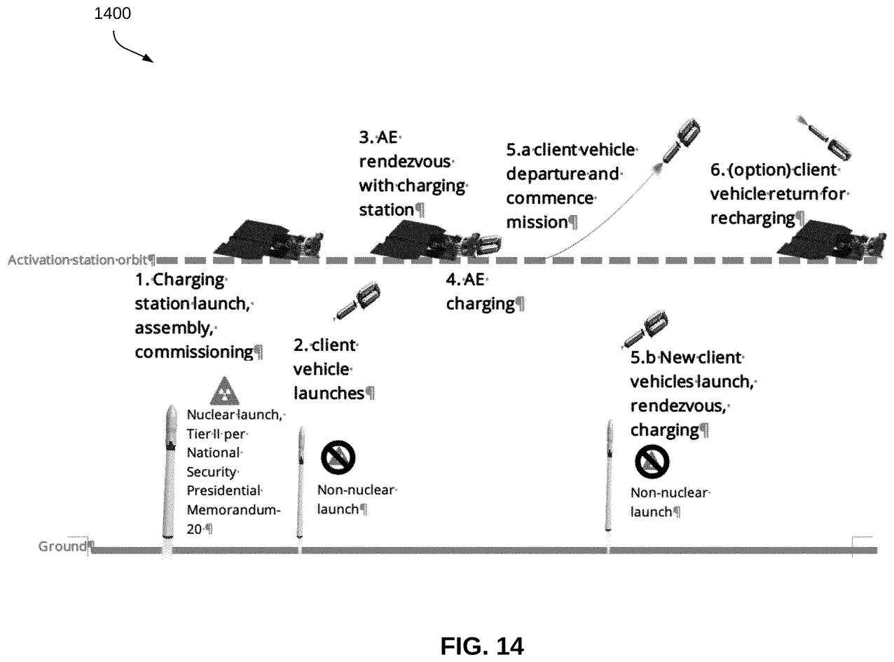

FIGS. 14-16 illustrate additional embodiments of operational concepts for the radioisotope power system discussed above. For example, FIG. 14 shows a scenario in which a radioisotope power system (i.e., charging station) is launched, assembled, and commissioned at an activation station orbit in space as a nuclear launch. A client vehicle, which does not contain nuclear materials, is then launched and directed to rendezvous with the charging station. Once charging of its batteries, isotope-powered propulsion system, and/or heating/electrical system are complete at the charging station, the client vehicle may then proceed to its programmed mission. Optionally, a new client vehicle may be launched and sent to rendezvous with the charging station, and/or the original client vehicle may return to the charging station for recharging as needed.

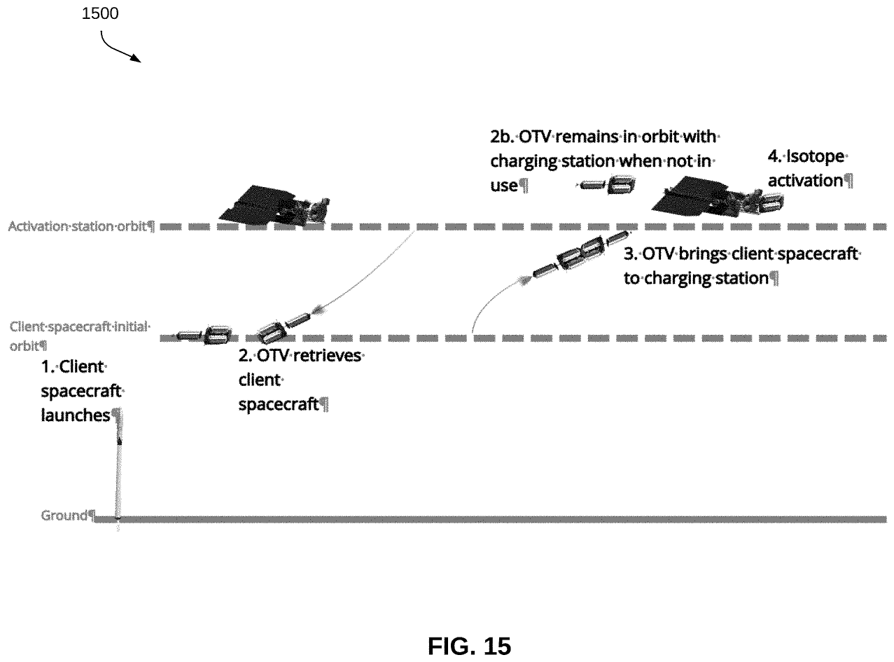

Any number of radioisotope power systems may be placed in any number of activation station orbits to service visiting spacecraft. For example, there could be several at different inclinations and altitudes to re-charge orbital transfer vehicles. Such a scenario is illustrated in FIG. 15. As shown in FIG. 15, a client spacecraft is launched into an initial orbit as either a nuclear or a non-nuclear launch. One or more charging stations is positioned in an activation station orbit, along with one or more orbital transfer vehicles. The orbital transfer vehicle can rendezvous with the client spacecraft to either bring the client space craft to a radioisotope power system at the activation station orbit for isotope activation. The orbital transfer vehicle may remain in orbit with the charging station when not in use. Once the isotope activation for the client spacecraft is completed, the client spacecraft may proceed with its programmed mission, with or without further assistance from the orbital transfer vehicle.

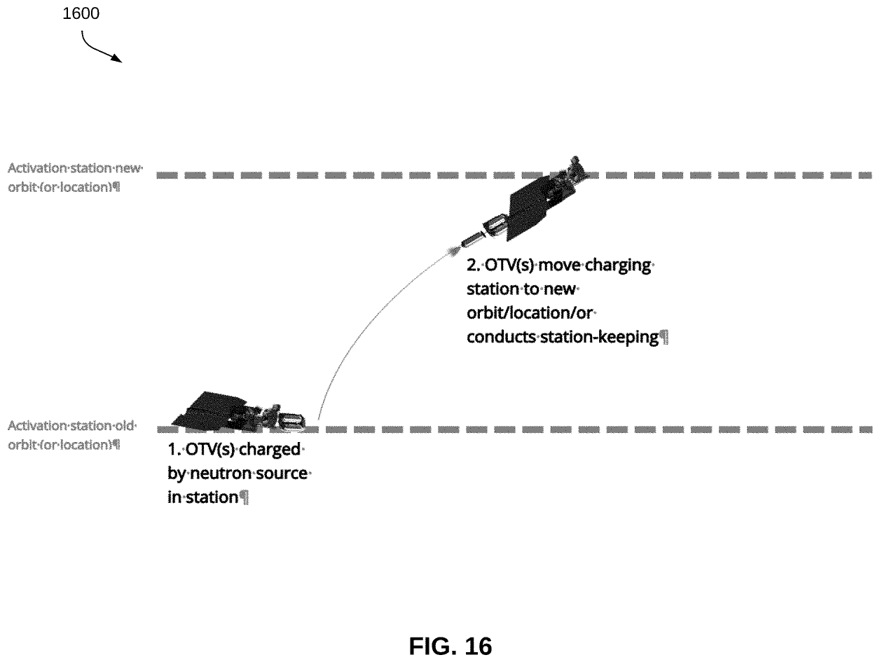

The orbital transfer vehicle may also include isotope propulsion systems that can be activated and/or recharged by the radioisotope power system at the charging station. Additionally, the orbital transfer vehicle may be used for moving the charging station itself to new locations. For instance, the orbital transfer vehicle may be used to change the activation station orbit of the radioisotope power system or to move the charging station to a desired location, such as to a planet or a space station, as shown in FIG. 16. The radioisotope power system may also be used to irradiate any manner of items, such as for research purposes or for charging other machinery. For example, due to the high neutron fluxes in the reactor core, the disclosed radioisotope power system may also be used for nuclear research in space, possibly alleviating regulatory constraints for Earth-bound research reactors. Additionally, the radioisotope power system disclosed herein may benefit from or leverage technologies of, e.g., high-fidelity reactor physics and thermal-hydraulics software codes. That is, the radioisotope power system of the present disclosure may also be used to conduct research in space that is not feasible in a terrestrial reactor with lower tolerance for errant irradiation risk. Further, alternate embodiments of the same process facilitate rocket propulsion in other environments, to include terrestrial environments.

A neutron-flux trap type reactor in orbit may be used to irradiate other types of items (such as other types of thrusters or radioisotope electrical power sources) by neutron capture or other secondary reactions to produce radioisotopes within the item. For example, U.S. Provisional Patent Application No. 63,184,138, filed Apr. 5, 2021 and entitled “RADIOISOTOPE ROCKET THRUSTER SYSTEM AND METHOD OF USE,” which application is incorporated herein in its entirety by reference, describes a neutron-flux trap type reactor suitable for integration with the radioisotope rocket thruster system described herein.

Listed below are some of the possible propulsion systems that may utilize the space-borne flux-trap reactor for activation:
Plasma thermal
   The radiation produced by the activated isotope directly heats a propellant. For example, alpha or beta particle emission emitted within propellant and heating it without an intermediate medium.
Thermal
   This concept is similar to a nuclear thermal rocket. The activated isotope produces radiation that is absorbed in a metal or ceramic which in turn heats up, and transfers that heat to a propellant. The metal or ceramic may be solid, liquid, or gas. The present application would use short-lived isotopes produced in-situ, unlike previous publications (see, for example, E. L. Nezgoda, “RADIOISOTOPE PROPULSION TECHNOLOGY PROGRAM (POODLE): FINAL REPORT,” TRW Systems Group, 1967).
Alpha/beta magnetoplasmadynamic (MPD)
   This thruster type would rely on charged particle emission from radioisotopes (alpha or beta emission) to create a potential difference between electrodes, which when combined with an external magnetic field generates an axial force on ionized propellant accelerating it to high exhaust velocity.
Electrostatic
   Similar to the MPD thruster, charged particle emission creates high potential difference between electrodes in a simple isotope battery. The electrodes are wired directly to grid electrodes that produce an electric field that accelerates the ionized propellant. Furthermore, the ionization could be achieved by passing the propellant through the particle emission.
   The present application would use short-lived isotopes produced in-situ, unlike previous publications (see, for example, W. R. Mickelsen and C. A. Lowe, “POTENTIALITIES OF THE RADIOISOTOPE ELECTROSTATIC PROPULSION SYSTEM,” in AIAA ELECTRIC PROPULSION CONFERENCE, Colorado Springs, 1963).
Activated neutron source, induced fission
   This thruster concept relies on isotopes being produced that emit neutrons either directly through decay or through other reactions induced by decay in another element. The emitted neutrons would cause fission in a propellant bearing a fissile isotope such as uranium-235.
   The present application would use short-lived isotopes produced in-situ, unlike previous publications.
Isotope-powered-arcjet/resistojet/ion thruster/plasma thruster
   This thruster concept would utilize an isotope battery activated within the orbiting reactor to generate electrical power for a conventional electric propulsion system, perhaps with minimal power conversion.
Direct thrust from radioactive emission
   The particle emissions (alpha/beta/neutron) from a radioisotope could also be used as a propellant themselves. The escaping alpha, beta, neutrons, or secondary particles would be emitted from one end of a vehicle to produce thrust. There are numerous ways this could be done.
   The present application would use short-lived isotopes produced in-situ, unlike previous publications, for example, such as those describing concepts that include a sail coated in a thin layer of isotope, or with radioisotope dust grains captured in a magnetic field and allowing particles to escape the field.
Thermionic emission driven MPD
   This thruster concept is similar to the alpha/beta MPD. Instead of using the charged particles directly to produce a voltage potential between plates, the radiation is used to generate heat, and the high temperature causes electrons to boil off of the surface of an emitter through thermionic emission. These low energy (i.e., on the order of ˜few eV) electrons would then migrate to a collector producing a low voltage with a high current. The propellant would then be flowed between the electrodes which are arranged to act as an MPD thruster. The low-voltage/high-current is better suited for an MPD thruster since the current is what causes the Lorentz force that drives the propellant. This concept also does not require external magnets.
Coupled Thermionic/MPD
   Alternatively, the thermionic emission could be used to power a conventional thermionic conversion system. A number of thermionic batteries filled with target isotope could be wired in series and/or parallel to match the current and voltage needed by a conventional MPD thruster. Power could thus be supplied directly to a conventional MPD thruster without the need for any power conditioning. The propellant may or may not also be flowed through the batteries to reduce space-charge effects in the thermionic batteries, and ionize the propellant before entering the thruster.
   Because this combination of closely coupled thermionic isotope battery and propulsion is unique (not requiring any power conditioning), it could also use isotopes produced on the ground.

For all of the thruster concepts listed in above, any mix of isotopes may be used to tailor the thrust, specific impulse, and/or burn time for a given mission or application. For instance, the exponential decay of power may be leveraged as an exponentially decreasing thrust with constant Isp, constant mass flow rate with decreasing thrust and Isp, or some combination thereof. Similarly, for isotope power sources, longer lived (i.e., lower power) isotopes may be mixed with shorter lived (i.e., higher power) isotopes to provide more power for a short duration early, and lower power for longer.

The isotope may also be incorporated into thruster and/or battery components to help ionize, heat, or otherwise condition the propellant before being used in the thruster.

Furthermore, it could be possible to combine an isotope power source (like a radioisotope thermoelectric generator (RTG)) into one device (or separate, but physically adjacent to fit within the reactor flux trap), each having their own isotope(s). This would help enable deep space missions by providing propulsion and power by charging in the same reactor.

There are a variety of isotope power sources that may be activated by an orbiting reactor as described herein. Some types of these isotope batteries are listed below.
Radioisotope thermal
   This type of battery allows the isotope to generate heat, which is then converted to electricity by some conversion system, such as thermoelectric conversion, thermionic conversion, or electromechanical conversion.
Direct conversion, charge deposition
   This type of battery is similar to the electrostatic isotope thruster. Isotopes are placed on or within an electrode with another electrode place adjacent to it. charged particles (such as alpha and beta particles) with high energy are emitted and deposit their charge in the adjacent electrode producing electric field. The charge difference between electrodes can drive current, just as in a battery. While this concept is very old, it has not been used extensively due to the high voltages generated. The present application would use short-lived isotopes produced in-situ, unlike previous publications.
Direct conversion, semiconductor
   This uses charges from alpha or beta decay to produce potential within a semiconductor cell.
   The present application would use short-lived isotopes produced in-situ, unlike previous publications.

Note that because the propellant entering the chamber is kept at low mass-density, the stopping distance for emitted beta particles is quite long, which necessitates deflecting the beta particles into spiral paths with magnetic fields. Either axial or radial magnetic fields may be used to this effect. To help prevent the negatively charged betas from impacting the target material and getting re-captured, electrostatic fields are established between the target (or the cladding) and the walls or other components to deflect the orbits away. The orbits eventually migrate towards the anode(s), but this may be delayed long enough for the betas to transfer their kinetic energy to the propellant. Any number of combinations of electric and magnetic fields may be used to deflect the particles long enough to maximize their capture in the propellant. Additionally, nanoparticles, liquid droplets, or dense gasses (such as Xenon) may be added to the propellant to help stop the beta particles and transfer energy to the propellant.

As an example, for the 1.7 MeV beta particles emitted by phosphorus-32 (the activation product of natural phosphorus-31), the magnetic field strength for a 10 cm gyro radius is only 0.015 T. Analysis may determine an optimal geometric configuration of target material and magnetic and electric fields; particle transport simulations show that engines with void fractions up to 90% have power densities above 1 kW per kg of target phosphorus. It should be noted that although denser propellants (such as Xenon) are better at stopping the betas, almost any gas may be used. Solid propellants may be used by sublimating them at a controlled rate. Any molecular gas may be decomposed into its constituent elements due to the extreme temperatures, so a compound that is easily storable as a liquid or solid could be used (such as ammonia). Additionally, a propellant with the target material itself as part of the mix may allow the propellant to self-heat (although magnetic capture of the betas would still be necessary). Adding a powdered target material to the propellant may also help with beta heating or allowing the electrically charged powder to become trapped in the magnetic field as well.

Although the present disclosure has been provided in accordance with the implementations shown, one of ordinary skill in the art will readily recognize that there could be variations to the embodiments and those variations would be within the scope of the present disclosure. Accordingly, many modifications may be made by one of ordinary skill in the art without departing from the scope of the appended claims.

What is claimed is:

1. A radioisotope power system comprising:
a target material configured to receive neutrons emitted by a neutron source in space to activate the target material and to create a radioisotope material;
a propellant configured to receive controlled decay energy from the radioisotope material to result in at least one of increased propellant enthalpy and electricity.

2. The system of claim 1, wherein the target material is at least one of phosphorus, scandium, manganese, sodium, silicon-30, potassium-41, copper-63, zinc-68, yttrium, cobalt, bismuth, and other neutron activated isotopes.

3. The system of claim 1, wherein the neutron source is a nuclear reactor.

4. The system of claim 1, wherein the propellant is at least one of ammonia, alcohol, a noble gas, water, heavy water, a diatomic gas, an organic compound, SF₆ depleted UF₆, and a storable rocket propellant.

5. The system of claim 1, further comprising an ionizing radiation control system, wherein the ionizing radiation control system includes at least one of a magnetic field and an electrostatic field.

6. The system of claim 1, wherein the neutron source is located outside of the radioisotope power system.

7. The system of claim 1, wherein the target material is activated in space.

8. A method for producing thrust from a space-borne radioisotope power system, the method comprising:
providing the space-borne radioisotope power system including a target material and a neutron source configured to emit neutrons;
emitting neutrons from the neutron source in space;
directing the neutrons to the target material to create an activated target material;
producing decay energy from the activated target material; and
increase enthalpy of a propellant using the decay energy to produce thrust.

9. The method of claim 8, wherein increasing enthalpy of the propellant further includes converting heat to electricity to power an electric thruster.

10. A space-borne radioisotope power system, comprising:
a chamber containing a target material;
a neutron source in space for producing neutrons for activating the target material to produce a radioisotope material, the radioisotope material producing decay energy;
a propellant configured for receiving the decay energy to produce at least one of heat and electricity.

11. The space-borne radioisotope power system of claim 10, wherein the target material is at least one of phosphorus, scandium, manganese, sodium, silicon-30, potassium-41, copper-63, zinc-68, yttrium, cobalt, bismuth, and other neutron activated isotopes.

12. The space-borne radioisotope power system of claim 10, wherein the propellant is at least one of ammonia, alcohol, a noble gas, water, heavy water, a diatomic gas, an organic compound, SF₆ depleted UF₆, and a storable rocket propellant.

13. The space-borne radioisotope power system of claim 10, further comprising a radiation shield.

14. The space-borne radioisotope power system of claim 13, wherein the radiation shield includes an adjustable opening for accepting at least a portion of a client spacecraft therein.

15. A method for operating a space-borne radioisotope power system, the method comprising:
providing the space-borne radioisotope power system, including a neutron source and a chamber containing a target material;
interfacing the space-borne radioisotope power system with a client spacecraft in space, the client spacecraft having been launched without nuclear materials contained therein;
producing neutrons using the neutron source in space;
activating the target material using the neutrons so produced to produce a radioisotope material;
producing decay energy from the radioisotope material; and
using the decay energy to produce at least one of heat and electricity.

16. The method of claim 15, wherein using the decay energy includes
providing a propellant, and
providing the decay energy to the propellant to increase propellant entropy.

17. The method of claim 16, further comprising converting heat to electricity to power an electric thruster.

18. The method of claim 15, further comprising charging an electric battery of the client spacecraft.

19. The method of claim 15, further comprising:
providing an orbital transfer vehicle; and
using the orbital transfer vehicle to navigate the client spacecraft to the space-borne radioisotope power system.

20. The method of claim 19, further comprising:
charging the orbital transfer vehicle at the space-borne radioisotope power system.
